(19) United States
(12) Patent Application Publication
(10) Pub. No.: US 2013/0295358 A1
(43) Pub. Date: Nov. 7, 2013

(54) LAMINATED GLAZING

(71) Applicants: Peter Paulus, Muenster (DE); Shirley Anne Sergeant, Kingsley (GB); David Michael Bugg, Andover (GB)

(72) Inventors: Peter Paulus, Muenster (DE); Shirley Anne Sergeant, Kingsley (GB); David Michael Bugg, Andover (GB)

(73) Assignee: Pilkington Group Limited, St. Helens (GB)

(21) Appl. No.: 13/990,690

(22) PCT Filed: Dec. 1, 2011
(86) PCT No.: PCT/GB11/52373

§ 371 Date: Jul. 26, 2013

(30) Foreign Application Priority Data
Dec. 1, 2010 (GB) 1020311.5

(51) Int. Cl. B32B 17/10

(52) U.S. Cl. CPC B32B 17/10165
USPC 428/215; 156/106

(57) ABSTRACT

A laminated glazing comprising: a thick ply of glass having a thickness in the range 1.9 to 2.4 mm; a polymer interlayer; and a thin ply of glass having a thickness in the range 0.8 to 1.4 mm, wherein the relative optical power of the glazing is less than would be predicted from the single glass reflected optical power of the plies before lamination.

This invention relates to laminated glazing, to processes for producing laminating glazings and to uses for laminated glazings.

Vehicles often have laminated glazings comprising two glass sheets and a polymer interlayer between them. Automotive windshields, in particular, are laminated glazings.

Automotive manufacturers wish to reduce the weight of vehicles including by reducing the weight of the vehicle glazings. Reduction of glazing weight can be achieved by the use of different constructions, for example a non-laminated single ply of glass, a single glass ply and a polymer layer (a bi-layer construction) or by using materials other than glass (e.g. plastics such as polycarbonate). However, many of these alternative constructions have disadvantages compared to conventional laminated glazings such as poor scratch resistance, impact resistance (especially stone impact resistance) or poor optical quality. Alternative constructions are even more problematic because the required properties (including impact resistance and optical quality) of automotive glazings are continually improving.

In the past, asymmetric laminates have been constructed where the thickness of the glass plies differs.

For example, US 2010/0214194 discloses a head up display in a windshield with glass plies of different thickness.

GB-B-1580366 discloses a thick outer ply and thin inner ply to ensure that the fragments of glass formed when the windshield breaks are as small as possible to reduce the extent of injury in the event of a collision. This type of construction has mainly been superseded with the legal requirement that vehicle seat belts be fitted and worn. GB-B-1339980 relates to a similar problem.

WO 2010/0036219 and WO 2010/102282 relate to thick/thin glass plies with ionomer polymer interlayers.

DE 102006042538 discloses a laminate with thick/thin glass plies, the thin ply having a functionalised surface.

WO2010/121986 discloses a transparent laminated glass containing a glass outer pane 1.45 mm to 1.8 mm thick and an inner pane 1.0 to 1.4 mm thick.

It has always been thought that reducing the thickness of one or both glass plies would lead to unacceptable optical distortion in the laminate and this has been true in prior art constructions as referred to above. This is because float glass exhibits float drawlines (waviness) which are longitudinal waves on the glass along the draw direction of the float process. These waves become visible when the glass plies are laminated. It is known that the number and severity of drawlines depends upon manufacturer and the manufacturing line, but also depends on draw speed and glass thickness: the lower the speed the less distortion, the thicker the glass the less distortion. Generally for the same glass composition manufactured on the same float line, the mean reflected optical distortion increases by approximately 50-100% when the thickness of the glass ply is reduced from 2.1 mm to 1.0 mm.

Furthermore, it has been known that the transmittive optical distortion (i.e. the distortion that the driver of a vehicle sees) may be predicted by determining the average of the reflected distortion of the two plies. The optical performance is correlated to the average mean reflected distortion of the single plies.

With modern specifications for distortion (which have been becoming more strict), thin plies below 1.6 mm in thickness are generally considered to not be useful in laminated glazings because of the optical distortion.

It has also been considered that thinner glass constructions are likely to be less safe because impacts are more likely to penetrate or damage to a degree requiring replacement (e.g. by generating long cracks).

Surprisingly the inventors of this application have discovered that by carefully selecting the thickness of the glass plies in a laminated glazing, it is possible to reduce the optical distortion to acceptable levels even if a thin (and therefore light) glass ply is used. Furthermore it has surprisingly been discovered that such laminates are at least as impact resistant (and may be even more resistant) than thicker constructions.

The present invention accordingly provides a laminated glazing comprising, a thick ply of glass having a thickness in the range 1.9 to 2.4 mm, a polymer interlayer, and a thin ply of glass having a thickness in the range 0.8 to 1.4 mm, wherein the relative optical power (i.e. distortion) of the glazing is less than would be predicted from the single glass reflected optical power (i.e. distortion) of the plies before lamination.

In a second aspect of the present invention, there is provided a method of reducing the optical distortion of laminated glazings, the method comprising providing a thick glass ply having a thickness in the range 1.9 mm to 2.4 mm, providing a polymer interlayer, and providing a thin glass ply having a thickness in the range of 0.8 mm to 1.4 mm, laminating the thick glass ply, the polymer interlayer and the thin glass ply together, whereby the relative optical power (i.e. distortion) of the glazing is less than would be predicted from the single glass reflected optical power (i.e. distortion) of the plies before lamination.

Preferably, the laminated windshield has a relative optical power at least 10% less than that predicted from the single glass reflected power of the plies before lamination. More preferably, the laminated windshield has a relative optical power at least 20% less, or at least 25% less, or at least 30% less, or at least 35% less, or most preferably at least 40% less than that predicted from the single glass reflected power of the plies before lamination.

Preferably, the thick ply of glass has thickness in the range of 1.9 to 2.3 mm, preferably 1.95 mm to 2.25 mm, or 2.0 to 2.2 mm, or 2.05 mm to 2.15 mm and most preferably about 2.1 mm.

Preferably, the thin ply of glass has a thickness in the range 0.9 to 1.35 mm, more preferably 0.9 to 1.3 mm or 0.9 to 1.25 mm, or 0.9 to 1.2 mm and most preferably 0.9 to 1.15 mm or 0.9 to 1.1 mm or 0.95 to 1.05 mm. It is most preferred if the thickness of the thin glass ply is approximately 1.0 mm.

The ply of interlayer material may be a flexible plastics material, which may be clear or body-tinted. Suitable interlayer materials include polyvinyl chloride (PVC), polyurethane (PU), ethyl vinyl acetate (EVA), polyethylene terephthalate (PET) or polyvinylacetal, preferably polyvinylbutyral (PVB), the most usual choice for lamination being PVB. The ply of interlayer material is typically provided in a thickness of between 0.38 and 1.1 mm, but most commonly 0.76 mm.

The interlayer may be an acoustic interlayer such as a modified PVB to provide acceptable acoustic performance (which may be particularly advantageous in view of the low thickness of the laminate according to the invention).

Generally, the polymer interlayer will comprise polyvinylbutyral (PVB), ethylvinyl acetate (EVA), or a thermoplastic polyurethane (TPu).

The laminate may have infra-red solar control (a coating on the glass or coated PET incorporated in the laminate), may use a solar absorbing interlayer and/or may include heating elements (wires or coating).

The glass of one or both glass plies may be clear or tinted.

A windshield formed from a laminate according to the invention may have one or more of the following components included: antenna, rain sensors, or camera systems.

In a third aspect, the present invention provides a method of laminating glass, the method comprising providing a thick ply of glass having a thickness in the range 1.9 to 2.4 mm, providing a polymer interlayer, providing a thin ply of glass having a thickness in the range 0.8 to 1.4 mm, laminating the thick ply, interlayer and thin ply under application of pressure in the range 8-15 bar and at a temperature in the range 110° C. to 150° C.

In a fourth aspect, the present invention provides the use of a thin ply of glass having a thickness in the range 0.8 to 1.4 mm in a laminated glazing further comprising a thick ply of glass having a thickness in the range 1.9 to 2.4 mm and a polymer interlayer, the use being to provide a relative optical power (i.e. distortion) of the glazing less than would be predicted from the single glass reflected optical power (i.e. distortion) of the plies before lamination.

The stone impact resistance of the laminated windshield will preferably be better than a symmetrical laminate having 2.1 mm thick glass plies.

Usually, the Weibull modulus of the laminated glazing (determined as described in relation to the Examples below) will be 10 or greater.

The Weibull modulus is a measure of the degree of scatter of the breaking strength data. When the Weibull modulus is low there is much scatter; when the Weibull modulus is high there is little scatter in the data, giving a material that is more predictable in its failure behaviour. Thus, the Weibull modulus is a measure of a beneficial property of a material.

Embodiments of the invention will now be described with reference to the accompanying drawings in which:

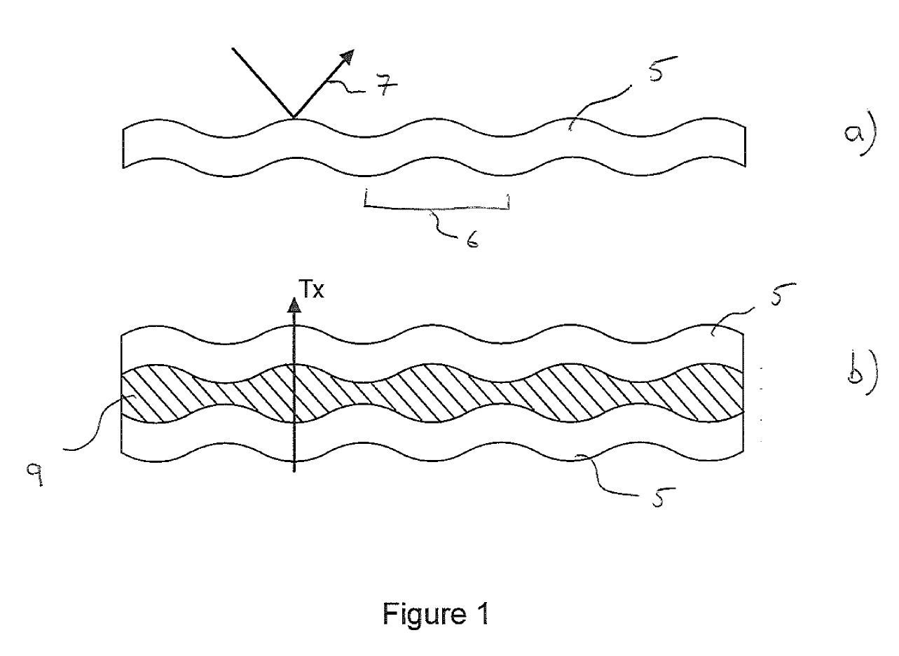

FIG. 1 illustrates float drawlines on single plies of float glass and also in laminated glazings comprising two float glass plies and a polymer interlayer.

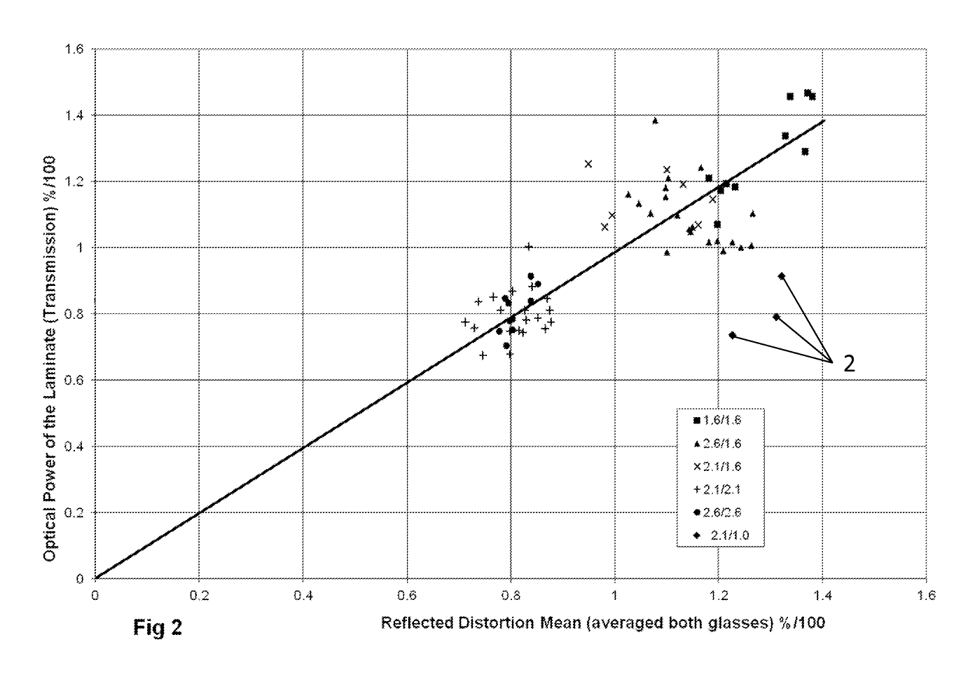

FIG. 2 illustrates a correlation graph showing the relationship between mean reflected distortion (averaged for both glasses in the laminate) and the optical power (which relates to distortion) of the laminate in transmission for a number of laminates of various constructions.

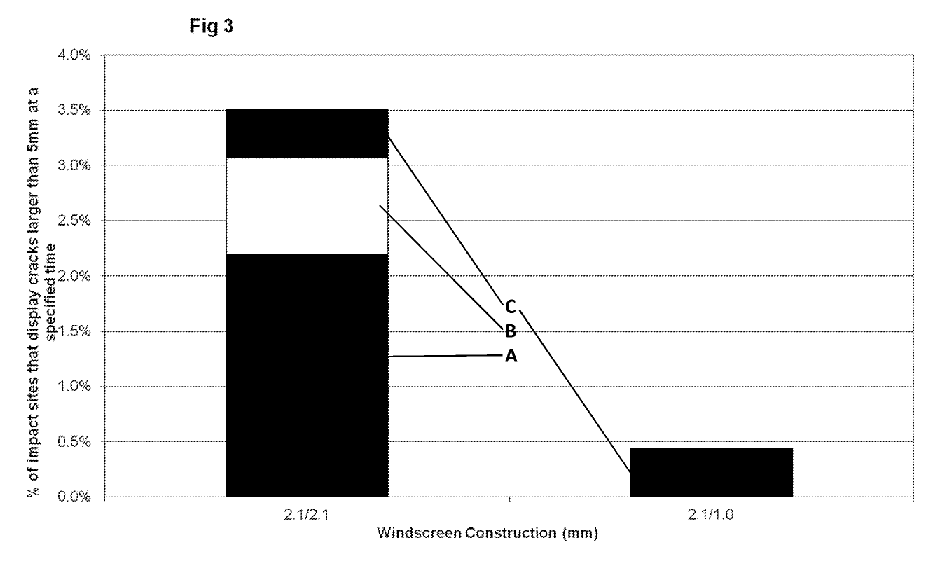

FIG. 3 illustrates a bar chart showing dart impact resistance data for 2.1/2.1 mm and 2.1/1.0 mm construction windscreens when testing for cracks larger than 5 mm and using a dart drop height of 750 mm.

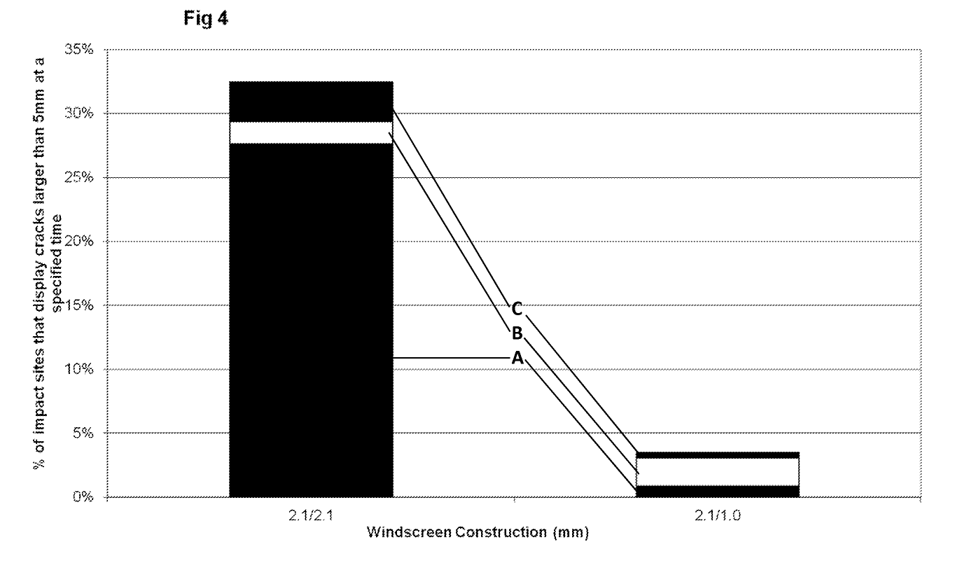

FIG. 4 illustrates a bar chart showing dart impact resistance data for 2.1/2.1 mm and 2.1/1.0 mm construction windscreens when testing for cracks larger than 5 mm and using a dart drop height of 1150 mm.

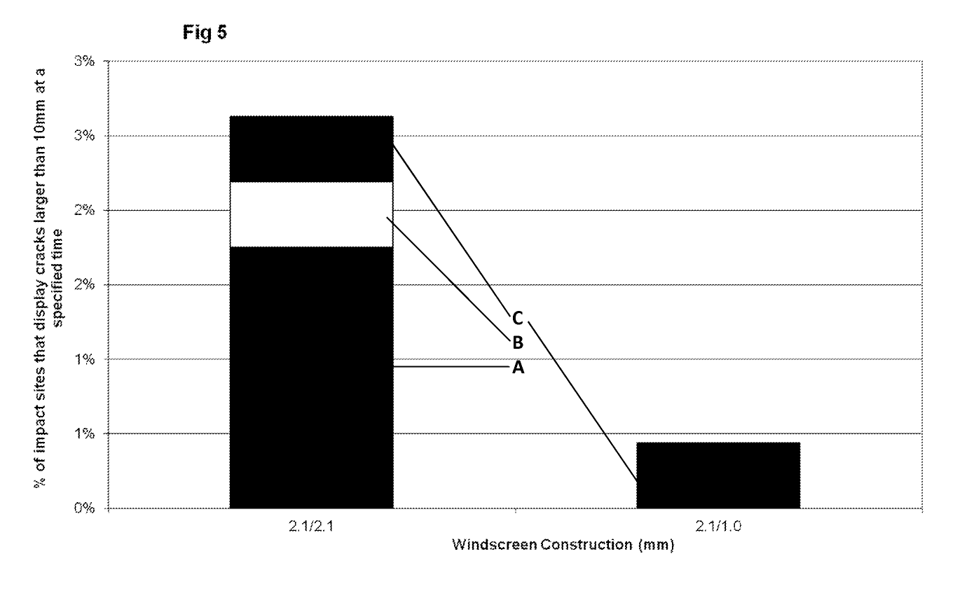

FIG. 5 illustrates a bar chart showing dart impact resistance data for 2.1/2.1 mm and 2.1/1.0 mm construction windscreens when testing for cracks larger than 10 mm and using a dart drop height of 750 mm.

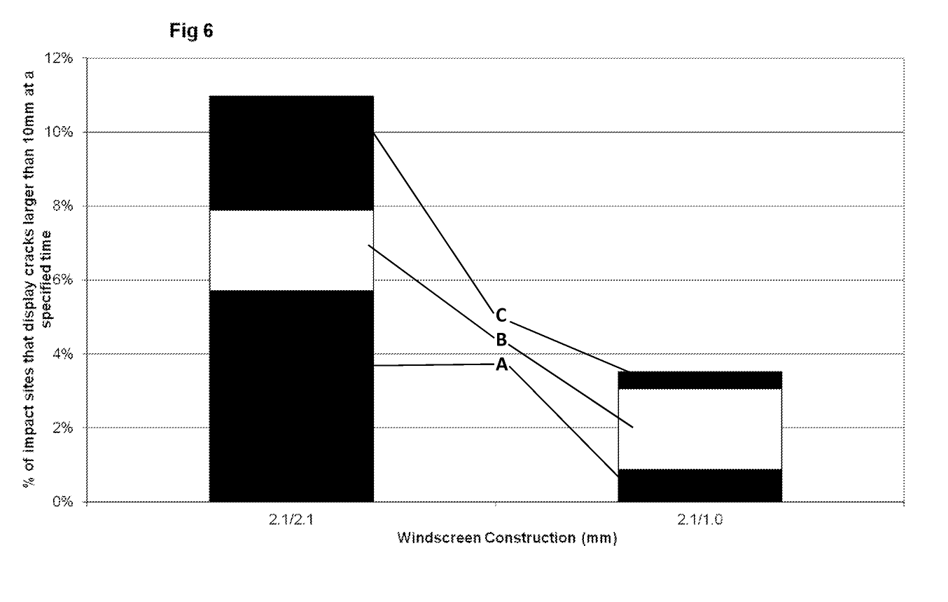

FIG. 6 illustrates a bar chart showing dart impact resistance data for 2.1/2.1 mm and 2.1/1.0 mm construction windscreens when testing for cracks larger than 10 mm and using a dart drop height of 1150 mm.

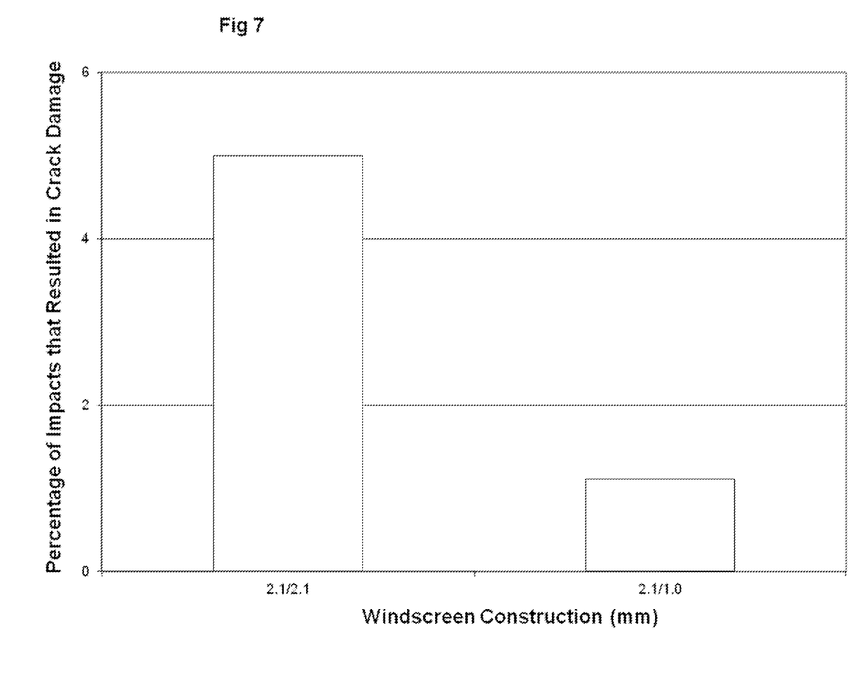

FIG. 7 illustrates a bar chart showing stone impact resistance data for 2.1/2.1 mm and 2.1/1.0 mm construction windscreens.

FIG. 1 illustrates schematically the effect of waviness (which results from the production process for float glass) on the distortion of the reflection from the surface of glass. In FIG. 1a) a single sheet of float glass 5 exhibits waviness 6 resulting in reflective distortion 7. The degree of waviness (and hence distortion) depends on the manufacturing parameters including speed of the float line. The degree of waviness tends to increase significantly with thinner glass. FIG. 1b) illustrates that when laminated the individual waviness of both single glass sheets 5 with a polymer interlayer 9 between them contribute to the optical power of the laminated glazing in transmission (i.e. distortion in transmission), as illustrated by Tₓ.

FIG. 2 is a graph of the relative optical power (i.e. distortion) of laminates as a function of the relative single glass reflected distortion mean (i.e. measuring first the mean of all absolute values of the reflected optical distortion of each of the single glasses of the laminate and then averaging both values for each of the single glasses of the laminate) showing that for laminates there is generally a direct relationship between the reflected distortion mean and the optical power of the laminate. In the graph, the different constructions listed in the legend are given in millimetres. For the avoidance of doubt, the units for both axes in FIG. 2 are “%/100” i.e. the value of, for example, 1.2 on either axis equates to 120%. The line of best fit does not take into account the data points for laminates according to the invention (2.1/1.0 mm). The values of the 2.1/2.1 laminate taken as the standard (referred to below) were taken as 100% and the values of the constructions on the graph determined as a percentage of the standard. The values of many of the other 2.1/2.1 laminates on the graph (generally clustered around 80%/80%) are because these laminates were constructed of glass sheets manufactured on a different float line under different conditions.

In FIG. 2 it is clear that for a laminate according to the invention (“2.1/1.0”) the optical power (i.e. distortion) 2 of the laminate is much less than would be predicted from the reflected distortion mean of the single glasses. In fact, glass 1.0 mm thick has a significant reflective distortion which, prior to this invention, would be considered to have a corresponding effect on the optical power of the laminate.

The present invention is also illustrated by the following examples in which laminated glazings were prepared according to the following procedure:

An interlayer material blank corresponding approximately to the shape of the curved glass plies used to form the glazing was laid up on a first ply of glass. The second ply of glass was placed on top of the interlayer material, and aligned with the first ply of glass, forming a laminate assembly. Excess interlayer material was trimmed from around the edge of the laminate assembly, which was pre-nipped via a vacuum bag at 95° C. for de-airing. Once de-aired, the laminate assembly was placed in an autoclave at 145° C. and a pressure of 10 bar, until fully bonded.

The interlayer material was polyvinylbutyral (PVB) 0.76 mm thick.

The optical distortion of the single thickness glass plies prior to lamination and of the laminated glass construction were determined using the following procedure:

The distortion of the single glasses was measured by analysing the reflective optical power. This was done by analysing the difference in deflection of reflected optical beams at a given distance. For measuring the distortion of laminated glasses, the optical power in transmission was used. A point light source was used to illuminate the glass and the projected shadow images were analysed, as discussed in US-A-2007/0036464. The optical distortion was compared to a 2.1/2.1 glass ply used as a standard (considered 100% reflected distortion).

The results of the comparison in the optical performance of various glazings having various thicknesses of glass plies are illustrated in Table 1.

TABLE 1
Comparison of Optical Performance of Laminated Glazings

| | |
|---|---|
| | Reflected Distortion |
| Single Thickness mm | Relative |

(a.i)

| | |
|---|---|
| 2.1 | 100% |
| 1.5 | 137% |
| 1 | 163% |

(a.ii)

| | |
|---|---|
| 2.1 | 100% |
| 1.5 | 137% |
| 1 | 157% |

| | | | |
|---|---|---|---|
| Laminated | | Comment | |
| Glass | Reflected Distortion | Regarding Optical | Optical Quality |
| Construction | Mean (Averaged | Quality of Laminate | of Laminate |
| (mm) | Both Glasses) % | (Relative) % | (Relative) % |

(b.i)

| | | | |
|---|---|---|---|
| 2.1/2.1 | 100% | Predicted from | 100% |
| (standard) | | correlation graph | |
| | | (FIG. 2) | |
| 2.1/1.5 | 118% | Predicted from | 118% |
| | | correlation graph | |
| | | (FIG. 2) | |
| 1.5/1.5 | 137% | Predicted from | 137% |
| | | correlation graph | |
| | | (FIG. 2) | |
| 2.1/1.0 | 131% | Measured for one | 79% |
| | | sample | |

(b.ii)

| | | | |
|---|---|---|---|
| 2.1/2.1 | 100% | Predicted from | 100% |
| (standard) | | correlation graph | |
| | | (FIG. 2) | |
| 2.1/1.5 | 118% | Predicted from | 118% |
| | | correlation graph | |
| | | (FIG. 2) | |
| 1.5/1.5 | 137% | Predicted from | 137% |
| | | correlation graph | |
| | | (FIG. 2) | |
| 2.1/1.0 | 129% | Measured for three | 81% |
| | | samples and | |
| | | averaged | |

Tables 1(a.i) and 1(a.ii) show average reflected distortion values for single glasses of given thicknesses. The difference between Tables 1(a.i) and 1(a.ii) is that a different set of samples was used to calculate the value for the 1 mm thick glasses.

Column 2 of Tables 1(b.i) and 1(b.ii) shows the average of the reflected distortion for the inner and outer glasses for each construction. The values in column 2 of Table 1(b.i) are calculated from the values in Table 1(a.i) whilst the values in column 2 of Table 1(b.ii) are calculated from the values in Table 1(a.ii).

As is clear from Tables 1(a.i) and 1(a.ii), the reflected distortion is inversely related to the thickness of the glass. Nevertheless, as seen in Tables 1(b.i) and 1(b.ii) the 2.1/1.0 laminate according to the invention has a significantly reduced optical power meaning significantly reduced distortion.

ANSIZ26 Standard Impact Test:

The laminated glazings were also subjected to windscreen impact testing to International regulation ANSIZ26. All six tested samples of the 2.1/1.0 laminate passed the tests.

Stone Impact Test: In addition, stone impact tests were carried out on both the invention construction 2.1/1.0 and standard 2.1/2.1 constructions. The method used small granite chips of mass 2 gram±10% projected onto the test windscreen at 64 kph, which was mounted at approximately the same angle that a windscreen would be glazed in a vehicle (approximately 60° from vertical). Six windscreens were tested for each construction, employing 30 impacts per windscreen. Cracks associated with the impacts were recorded and a crack rate (percentage of impacts that resulted in crack damage) calculated. See FIG. 7 for the results which clearly illustrates that the 2.1/1.0 construction according to the invention exhibits a far lower crack rate in this test than the standard 2.1/2.1 construction.

Further impact testing was conducted using a dart impact resistance method. The testing involved impacting the glass using a steel dart with a conical tip, which was projected on a trajectory perpendicular to the glass surface. The velocity of the dart upon impact was controlled and can be expressed either by a speed or an equivalent drop height. A variety of laminate constructions were tested. The dart had a mass of approximately 3.2 g. The dart test methods are based on techniques used within the industry, although no particular standard is followed. The speed at which the dart impacts the glass is varied by changing the drop height of the dart. Using this method two distinct dart impact studies were carried out.

Dart Impact Test on Small Flat Samples

Glass-PVB interlayer-glass samples were manufactured (as described above). These samples were then impacted on the thicker ply (for asymmetric constructions). The samples were impacted at two velocities equivalent to drop heights of 700 and 1150 mm.

Impacts at 700 mm drop height resulted in a small chip on the glass surface, which was then tested (with minimal delay after the impact event) using a standard flexure strength testing method (Ring-on-Ring) based on the standard ASTM C1499.

Data analysis was carried out using standard Weibull statistics which showed the Weibull modulus to be statistically significantly greater (based on 95% confidence limits) in the 2.1 mm/1.0 mm construction relative to the standard 2.1 mm/2.1 mm construction. See Table 2 for results.

When impacted with velocities equivalent to 1150 mm the higher impacter energy resulted in a certain percentage of samples with small chips (as with the lower drop height) and a certain percentage where long cracks (long cracks are generally termed those longer than 5 mm) are formed upon impact. The number of these long cracks was recorded for each construction and results are given in Table 3.

This kind of fracturing is particularly unacceptable to both customers and automotive manufacturers as it requires windscreen replacement.

TABLE 2

| | Weibull | Relative | |
|---|---|---|---|
| | Modulus | characteristic | |
| Construction | (m) | strength/Mpa | Notes: |
| 2.1/1.0 | 15.32 | 100% | Invention |
| 2.1/2.1 | 5.97 | 93% | Standard Construction |

TABLE 3

| | 2.1/2.1 | 2.1/1.0 | 1.8/1.3 |
|---|---|---|---|
| Cracks upon | 67% | 7% | 60% |
| impact: | | | |

Dart Impact Test on Windscreens

Laminated windscreens of the same model (shape and design) were impacted. 228 impacts were carried out at each drop height (750 mm and 1150 mm)—108 in a periphery region and 120 in the centre body region. The centre body region refers to anywhere on the windscreen excluding a peripheral band of width 100 mm. Centre body impacts should be spaced evenly throughout the region. The periphery region impacts were carried out using a template to ensure impact sites at three distances inboard from the glass edge. The distances being 7 mm, 14 mm and 21 mm inboard. For 108 total periphery impacts one third (36 impacts) were at each of these distances inboard.

FIGS. 3-6 show the dart impact resistance data for 2.1/2.1 mm and 2.1/1.0 mm construction windscreens when testing for cracks larger than 5 mm or 10 mm and using a dart drop height of 750 mm or 1150 mm. In each case the y-axis represents the percentage of impact sites that display cracks larger than either 5 mm or 10 mm at the specified time. The bars of the charts are separated into the specific times when the windscreens were assessed. The specified time is either labelled “A” (immediately after impact), “B” (at 2 hours after impact) or “C” (at 24 hours after impact).

Each of FIGS. 3-6 show that the 2.1/1/0 construction of the present invention exhibits far superior dart impact performance than the standard 2.1/2.1 construction.

1. A laminated glazing comprising:
a thick ply of glass having a thickness in the range 1.9 to 2.4 mm,
a polymer interlayer, and
a thin ply of glass having a thickness in the range 0.8 to 1.4 mm,
wherein the relative optical power of the glazing is less than would be predicted from the single glass reflected optical power of the plies before lamination.

2. A laminated glazing as claimed in claim 1, wherein the relative optical power of the glazing is at least 10% less than would be predicted from the single glass reflected optical power of the plies before lamination.

3. A laminated glazing as claimed in either claim 1, wherein the thick ply of glass has a thickness in the range 1.9 to 2.3 mm, preferably 2.0 to 2.2 mm.

4. A laminated glazing as claimed in claim 1, wherein the thin ply of glass has a thickness in the range 0.9 to 1.3 mm, preferably 0.9 to 1.2 mm, more preferably 0.9 to 1.1 mm.

5. A laminated glazing as claimed in claim 1, wherein the polymer interlayer comprises polyvinyl butyral (PVB), ethylvinyl acetate (EVA), or a thermoplastic polyurethane (TPU).

6. A laminated glazing as claimed in claim 1, installed as a vehicle glazing.

7. A laminated glazing as claimed in claim 6, wherein the thin ply is situated on the inside of the vehicle when installed.

8. A laminated glazing as claimed in claim 1, having Weibull modulus of 10 or greater.

9. A laminated glazing as claimed in claim 1, wherein the stone impact resistance of the laminated glazing is better than a symmetrical laminate having 2.1 mm thick glass plies.

10. A method of laminating glass the method comprising:
providing a thick ply of glass having a thickness in the range 1.9 to 2.4 mm;
providing a polymer interlayer;
providing a thin ply of glass having a thickness in the range 0.8 to 1.4 mm; and
laminating the thick ply, interlayer and thin ply under application of pressure in the range 8 bar to 15 bar and at a temperature in the range 110° C. to 150° C.

11. Use of a thin ply of glass having a thickness in the range 0.8 to 1.4 mm in a laminated glazing further comprising a thick ply of glass having a thickness in the range 1.9 to 2.4 mm and a polymer interlayer, the use being to provide a relative optical power of the glazing less than would be predicted from the single glass reflected optical power of the plies before lamination.

12. The use as claimed in claim 11, to provide Weibull modulii greater than that given with standard construction with regard to low energy dart impact strength.
